(19) United States
(12) Patent Application Publication
(10) Pub. No.: US 2015/0029810 A1
(43) Pub. Date: Jan. 29, 2015

(54) TIPPING EQUIPMENT FOR QUICKLY MIXING AND UNLOADING CONCRETE

(71) Applicant: GICALLA S.A., MADRID (ES)

(72) Inventors: Carlos Savall Palacio, Madrid (ES); Andres Savall Palacio, Madrid (ES)

(21) Appl. No.: 14/512,310

(22) Filed: Oct. 10, 2014

Related U.S. Application Data
(63) Continuation of application No. PCT/ES2013/000090, filed on Apr. 11, 2013.

(30) Foreign Application Priority Data
Apr. 12, 2012 (ES) 201200400

(51) Int. Cl. B28C 5/08

(52) U.S. Cl. CPC B28C 5/0818; B28C 5/0893
USPC 366/64

(57) ABSTRACT

Truck-mounted tipping equipment for mixing and discharging concrete quickly includes an open tipping bucket shaped as a rectangular prism in the front and a semi-truncated cone in the rear that narrows towards a hydraulic discharge trap-door. The mixing and discharge mechanism has a spindle in an oblique position, to which helical fins have been welded serving as an endless screw. The diameter of these fins varies with the helix having a larger radius in the front (nearest to truck's cabin), and a reduced diameter rear part. The spindle keeps the concrete in continuous movement during transportation to prevent it from setting, and continuously moves the concrete towards the rear hydraulic trap-door. The trap-door remains closed until the concrete needs to be discharged. Once the majority of the total load is extracted, the tank is tipped to the rear to discharge the remaining concrete.

### CROSS-REFERENCE TO RELATED APPLICATIONS

This is a continuation application of International Patent Application No.: PCT/ES2013/000090 filed Apr. 11, 2013, which claims the benefit of priority to Spanish Patent Application No.: 201200400 file Apr. 12, 2012. The full contents of the International Application are incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

The present application relates to a complete piece of construction industry or civil engineering equipment especially indicated to attach to conventional trucks for tasks that require the use of large amounts of concrete in short spaces of time.

### BACKGROUND OF THE INVENTION

When a large supply of concrete is needed quickly and in a short space of time, conventional concrete truck mixers present one main problem, which is that the truck's concrete inlet and outlet to discharge the concrete are too small. This characteristic means that the loading and discharging times are longer for the indicated needs.

To solve this problem, special equipment is made to transport concrete in the truck. The truck carries tipping equipment with a large capacity bucket or tank that has a hydraulic rear trap-door to discharge the concrete. This equipment can be filled easily and quickly as it is completely open on top. Once the tank is filled with concrete, it is transported to the place where it will be discharged. By tilting the tank, the concrete is discharged through the hydraulic rear trap-door. The problems that this equipment presents are, on the one hand, that the concrete can set due to the fact it remains static in the tank during transportation. This can be worse in areas with hot climates. On the other hand, this equipment can only discharge concrete by means of tipping, and, due to the heavy weight that is transported, the stability of the truck can be seriously compromised during concrete discharge.

### SUMMARY OF THE INVENTION

The present invention has the objective of using a complete piece of equipment especially indicated to attach to conventional trucks, and to guarantee a quick transportation and discharge of large amounts of concrete. The present application provides evident additional improvements to what is known as state-of-the-art.

The invention consists of tipping equipment for mixing and discharging concrete quickly. This equipment combines a quick concrete discharge process by means of an open tipping bucket with a special morphology: the front part is in the shape of a rectangular prism with curved angles to avoid vertexes and lower edges, combined with a design of the rear part in the shape of a semi-truncated cone, becoming narrower towards the hydraulic discharge trap-door. This delays the setting of the concrete thanks to the incorporation of a mixing and discharge mechanism inside the loading bucket, and the incorporation of an aluminum hydraulic cover on top.

The mixing and discharge mechanism has a spindle in an oblique position, to which helical fins have been welded serving as an endless screw. The diameter of these fins is variable, so that, in the front part (the part which is nearest to truck's cabin), the helix has a larger radius, and it is reduced in the rear part. The aforementioned spindle has two functions: on the one hand, it keeps the concrete in continuous movement during transportation avoiding it to set. The helical fins, moved by the oblique spindle, continuously stir the concrete moving it towards the rear where the hydraulic trap-door is. This trap-door will remain closed until the concrete needs to be discharged. The rotation speed can be regulated according to the function of the concrete type being transported.

The concrete recirculates on the lower and lateral part towards the base of the bucket, pushing the load at the rear towards the area where the helix is, avoiding the concrete to solidify. It is then constantly re-entering the forced movement of the mixing combination, achieving a continuous and homogeneous mix during transportation.

On the other hand, once the truck is positioned where the concrete needs to be discharged, the discharging trap-door is opened by hydraulic drive, and the rotation speed is adjusted to each case, proceeding, then, to the extraction and discharge of the concrete without the need of tipping. Once the helical fins are not able to extract any more concrete (in this manner almost 70% of the total load is extracted), the following procedure is to tip the tank to discharge the remaining concrete, which will come through the same outlet. Due to the fact the tank is practically empty, the stability of the vehicle increases.

With regard to filling the tank, this equipment has aluminum covers on top that, by means of hydraulic drive, completely open to introduce the concrete from a loading hopper at a concrete mixing plant. In this sense, the concrete can be introduced at the maximum speed that said hopper can discharge, as it does not depend on the rotation of the bucket as in conventional concrete truck mixers.

Once the tank, or the pear-shaped bucket, is loaded, the aluminum covers are closed so that the concrete is covered during transportation.

### BRIEF DESCRIPTION OF THE DRAWINGS

To complement the description, and to make comprehension of the invention's characteristics easier, several drawings accompany this present descriptive report. In a descriptive and non-limiting manner, the following has been represented:

FIG. 1 shows the lateral part of the equipment, where the following is highlighted:

A) Spindle with helical fins

B) Rear hydraulic trap-door

C) Covers on top with hydraulic drive

D) Pear-shaped bucket or tank for tipping

E) Auxiliary superstructure frame

F) Hydraulic cylinder for tipping

G) Tipping point of the bucket

H) Hydraulic motor

I) Gearbox

J) Rear spindle support

FIG. 2 shows the equipment from above with the covers open (C).

FIGS. 3 and 4 respectively show top plan and side elevational views of the equipment assembled on a truck.

### DESCRIPTION OF THE PREFERRED EMBODIMENTS

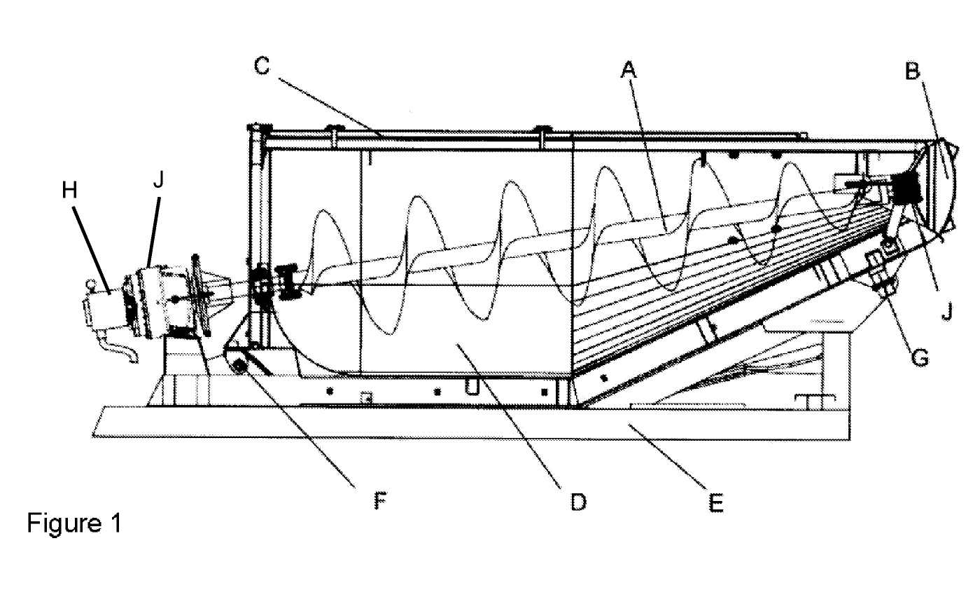

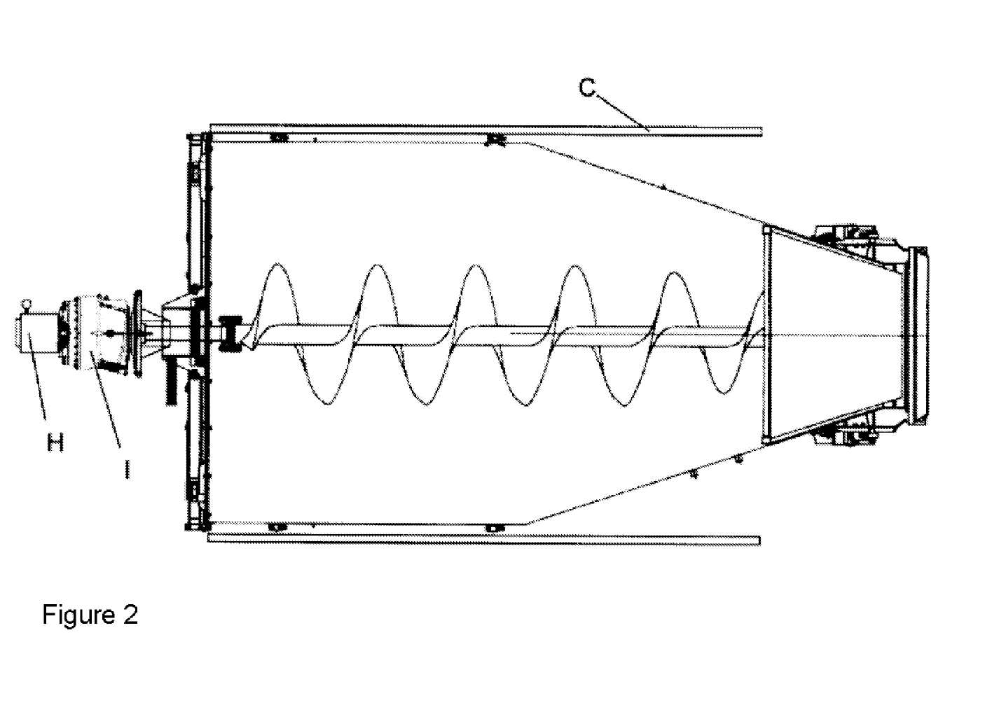

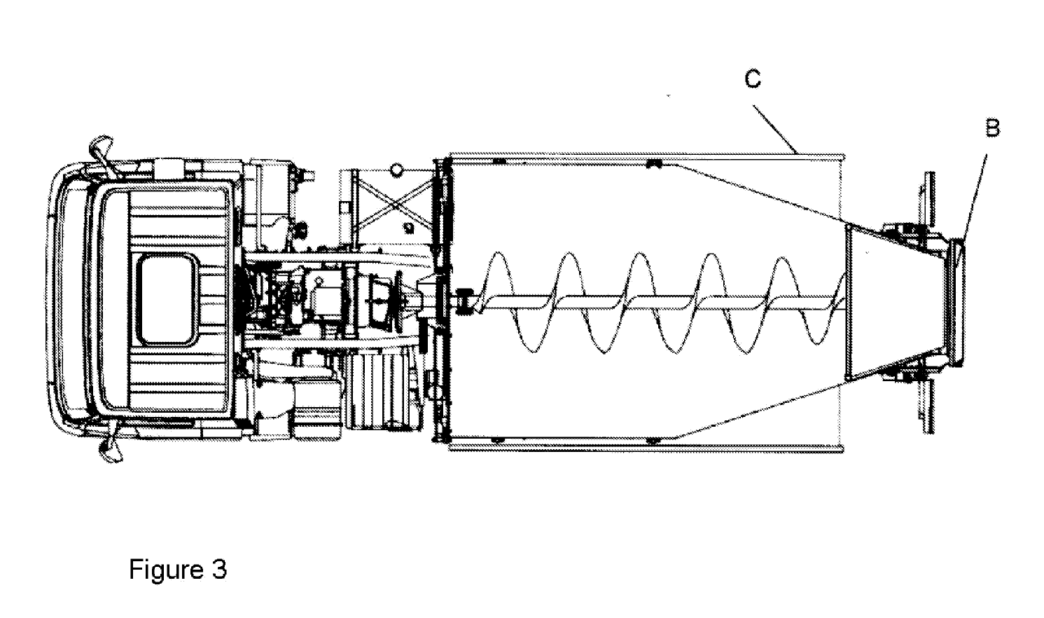

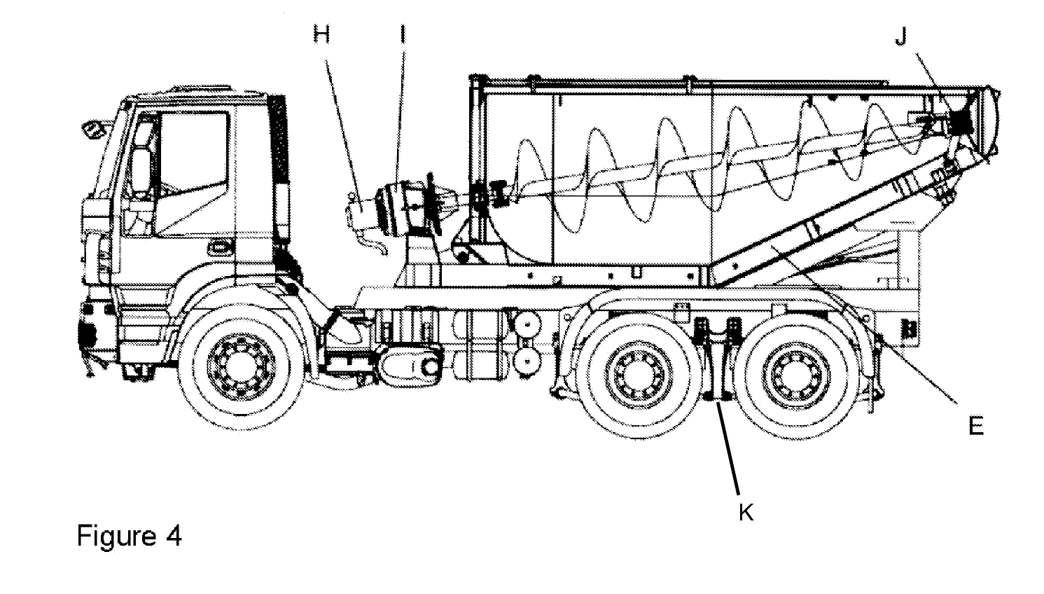

As observed in FIG. 1, the invention is tipping equipment for mixing and discharging concrete quickly to attach to trucks. The equipment is attached to the truck by means of a superstructure consisting of an auxiliary frame (E) supporting the bucket or tank (D). The rear part of this frame is in the shape of a wedge, allowing it to tilt with regard to a point located at a higher position (G). In addition, on the lower part of the inside the bucket, there is a hydraulic vibrator used to prevent the concrete from sticking to the walls during transportation.

The driving devices of the tipping system (F) and the spindle moving system with helical fins (A) are completely independent.

The described rotational helix, formed by a spindle and a set of helical fins (A) welded to it with variable radii, can be disassembled. On the lower part (where the helixes are larger), the spindle has an ending in the shape of an annulus with spaces to insert screws. On the top part, closest to the rear discharge trap-door, the spindle has an ending with a smaller diameter than the rest to tightly attach the rear support (J) fixed to the loading bucket or tank.

The truck, to which the equipment will be attached, must have power take-off, similar to Multipower, which will act as a hydraulic pump by means of a Cardan joint shaft.

This pump will pressure inject the oil through a rigid pipeline system arranged along the auxiliary frame (E) and the base of the loading bucket up to the hydraulic motor (H) attached to the gearbox (I). This then produces a rotational movement in the main spindle of the system with a special connection plate. Before returning to the deposit, the oil is passed through a heat exchanger by forced air in order to cool it.

Optionally, to improve the stability of the vehicle when discharging concrete on unstable ground and/or to elevate the unloading point, there are stabilizers or supports (K) at the rear of the truck joined to the chassis. This allows the vehicle to lift 32 tons to a maximum height of 500 mm.

As part of the essential features of the invention, we can mention variations of detail, that are also protected, as well as the bucket or tank that can be varied in size or dimensions, implying the variation of the spindle that moves the helical fins.

While several illustrative embodiments of the invention have been shown and described, numerous variations and alternate embodiments will occur to those skilled in the art, and can be made without departing from the scope of the invention as defined in the appended claims.

What is claimed:

1. Equipment adapted to attach to trucks for mixing and quickly discharging concrete, comprising:
a tank with a front part in the shape of a rectangular prism with curved angles, and a rear part in the shape of a semi-truncated cone that becomes narrower towards a hydraulic discharge trap-door, a mixing-discharging mechanism located on the inside of said tank for mixing concrete therein and urging it toward the discharge trap-door, and hydraulic aluminum covers over the tank allowing concrete to be introduced through a top opening in the tank.

2. The equipment of claim 1, wherein the mixing-discharging mechanism includes a spindle oriented in an oblique position, and helical fins welded to the spindle that provide an endless screw which has a larger radius in the front part nearest to a cabin of the truck, and becomes narrower towards the rear.

3. The equipment of claim 1, wherein the hydraulic trap-door remains closed until the concrete is discharged.

4. The equipment of claim 1, further including an independent hydraulic system for elevating a front part of the tank and tipping the concrete therein toward the hydraulic trap-door.

5. The equipment of claim 4, further including stabilizers or supports adapted to be fixed to a rear chassis of the truck such that the independent hydraulic system can lift the tank weighing 32 tons to a height of 500 mm.

6. The equipment of claim 4, wherein the tank rotates about a fulcrum point located at an elevated rear position on an auxiliary frame that is adapted to mount on the back of the truck.

7. Equipment adapted to attach to trucks for mixing and quickly discharging concrete, comprising:
a tank mounted to an auxiliary frame that is adapted to mount on the back of a truck, the tank having a front part in the shape of a rectangular prism with curved corners and a rear part in the shape of a semi-truncated cone becoming narrower and being angled upward towards a rear opening, the tank having an upper opening closed by removable covers that allow concrete to be introduced through the upper opening;
a mixing-discharging spindle located on the inside of said tank for mixing concrete therein and urging it toward the rear, the spindle oriented in an oblique position so as to angle upwardly and terminate adjacent the rear opening, the spindle having helical fins thereon that provide an endless screw; and
an independent hydraulic system mounted on the auxiliary frame for elevating a front part of the tank and tipping the concrete therein toward the rear opening.

8. The equipment of claim 6, wherein the helical fins on the spindle have a larger radius in a front part and gradually reduced radii towards the rear.

9. The equipment of claim 6, further including a hydraulic discharge trap-door over the rear opening that remains closed until the concrete needs to be discharged.

10. The equipment of claim 6, further including stabilizers or supports adapted to be fixed to a rear chassis of the truck such that the independent hydraulic system can lift the tank weighing 32 tons to a height of 500 mm.

11. The equipment of claim 6, wherein the tank rotates about a fulcrum point located at an elevated rear position on the auxiliary frame.

12. The equipment of claim 6, wherein the removable covers comprise hydraulically-actuated aluminum covers.
